(19) United States
(12) Patent Application Publication
(10) Pub. No.: US 2005/0160034 A1
(43) Pub. Date: Jul. 21, 2005

(54) Convertible debt hedge

(76) Inventors: Kevin G. Woodruff, New York, NY (US); Serkan Savasoglu, New York, NY (US); Nathan McMurtray, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/759,905

(22) Filed: Jan. 16, 2004

(51) Int. Cl. G06F 17/60

(52) U.S. Cl. 705/39; 705/1

(57) ABSTRACT

In various embodiments of the present invention, aggregate transactions and methods for structuring aspects of aggregate transactions are provided. Aggregate transactions are provided that include a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component. The integrated aggregate transaction also includes at least one of the following additional features: a derivative contract having a strike price structured to be adjusted up to a maturity date of the derivative contract; at least a portion of the convertible debt hedge is structured to be exercised automatically upon conversion of at least a portion of the convertible debt component by the investor; a derivative contract structured to be voidable at the option of at least one of the issuer and a counter-party to the derivative contract, or structured to be automatically terminated, if the investor exercises a change of control put on the convertible debt component; and/or, a derivative contract structured to become voidable at the option of at least one of the issuer and the counter-party to the derivative contract, or structured to be automatically terminated, upon an event of default of the convertible debt component by the issuer.

### BACKGROUND

There are a variety of investment strategies and financial instruments that firms, companies, corporations, and other entities may employ to raise capital for their business endeavors. Many entities issue basic securities such as straight debt and common stock, for example, in order to raise capital. A straight debt security (e.g., a bond, a note, a loan, or a mortgage) raises capital by arranging for an entity to repay a principal amount of borrowed debt, and interest on that debt, throughout the life of the security. A common stock security raises capital by selling an equity interest in the entity.

In addition to basic types of securities, entities seeking to raise capital also have a variety of hybrid investment instruments and structures at their disposal. Hybrid securities may combine attributes of different basic securities such as by combining a debt component and an equity component, for example. Hybrid securities may also be structured with features that change at predetermined points in time or that vary depending on certain market conditions. A convertible debt security, for example, can be structured to provide its holder with the option to exchange the convertible debt for other securities (e.g., common stock) at a predetermined conversion price. The conversion price, or the effective price of the common stock for which the convertible debt is exchanged, is typically set at a premium with respect to the price of the common stock at the time the convertible debt is issued. Despite the premium, convertible debt securities are attractive to investors due to their capacity for earning interest like a bond when the common stock price is below the conversion price, while realizing value like common stock when the stock price rises. In many situations, the potential value of a convertible debt security is sufficient incentive for an investor to accept a lower interest rate on the convertible debt than might normally be acceptable to the investor for non-convertible types of debt instruments.

Because a holder of a convertible debt security usually has the option (but not the obligation) to exercise the conversion feature at a time of its choosing, an issuer of the convertible debt security may be forced to deliver an amount of the security into which the debt is convertible at a time that is not beneficial to the issuer. Under normal circumstances, a convertible debt security investor can be expected to exercise the conversion option when the value of the security into which the debt is convertible exceeds the conversion price. In this scenario, the issuer loses value by being forced, in effect, to sell securities into which the debt is convertible (e.g., common stock) for a price lower than the current market value of the securities. It can be seen that issuers assume exposure to the risk of a below-market sale of securities in association with issuance of the convertible debt security until maturity or conversion of the convertible debt. Issuers may be willing to accept such risk exposure, however, because the benefits of issuing convertible debt, including the benefit of issuing debt at an interest rate comparatively lower than other instruments, may compensate for this risk. Upon issuance of a convertible debt security, unknown variables for an issuer include the timing of the exercise of the conversion option and the market value of securities into which the debt will be convertible. In certain situations, an investor may exchange the convertible debt for common stock at a market price so far above the conversion price that it would have been a preferable initial choice for the issuer to have selected an alternative security (e.g., non-convertible debt) instead of the convertible debt security.

To limit the risks associated with issuance of a convertible debt security, an issuer may simultaneously enter into one or more derivative contracts to attempt to hedge the obligation to deliver securities to an investor who decides to convert the convertible debt. Such derivative contracts usually are call options on securities of the same type as the securities into which the debt is convertible. The call option gives the issuer the right to purchase the securities at either a specified time or at a time chosen by the issuer at a specified price (known as the “strike price”). The strike price is selected to limit the risks of the convertible debt to a level acceptable to the issuer. Because the decision whether or not to exercise the call option is held by the issuer, a premium may be paid by the issuer to the counter-party to the derivative contract. By purchasing call options, risk to the issuer associated with issuing the convertible debt security is limited to the premium paid for the call options plus the difference, if any, between the strike price of the call option and the conversion price of the convertible debt. When a convertible debt investor exercises the conversion option, the issuer can meet its obligation to provide securities to the investor by delivering securities purchased through exercising the call option. The issuer may vary the risk exposure associated with issuing convertible debt securities by purchasing less (or more) call options than necessary to hedge the full amount of securities into which the convertible debt can be exchanged.

Another strategy that allows an issuer of a convertible debt security to minimize risk involves the issuer entering into derivative contracts that effectively provide a higher conversion price than normally would be possible for a convertible debt security offered at the desired interest rate. The issuer may purchase call options at a strike price equal to the conversion price of the convertible debt security and also sell call options at a strike price above the conversion price. This combination of simultaneously purchasing and selling call options at different strike prices is known as a call spread. By issuing the convertible debt and establishing a call spread, the issuer obtains a higher conversion price, because the option to convert possessed by convertible debt investors is offset by the lower strike price call options that the issuer has purchased. This is because the issuer can meet an exercised conversion obligation by delivering securities obtained through exercising the lower strike price call option rather than issuing new securities. The higher strike price call option effectively provides a new conversion price, because the issuer is only forced to issue (or otherwise acquire and deliver) additional amounts of the securities into which the debt is convertible if the price of the securities reaches the higher strike price. It can be seen that the cost to the issuer of reducing risks by increasing the effective conversion price is reduced by the value obtained from sale of the higher strike price call options.

From the perspective of the issuer, there are disadvantages associated with the accounting treatment of the derivative contracts to which it is a party. For accounting purposes, call options are generally treated as derivative contracts. Such treatment means that the issuer is required to account for changes in the value of the derivative contracts during the life of the options. Such changes in value may unpredictably impact reported income of the issuer. Issuers and professionals engaged in evaluating investments, generally view unpredictable changes in reported income as undesirable, especially because such changes increase the difficulty of making meaningful comparisons with financial results of prior reporting periods or with the financial results of other entities.

The issuer also faces disadvantages associated with the tax treatment of derivative contracts. In particular, premiums paid for call options written by the issuer on its own stock are not tax deductible. However, if the premium had been included in the convertible debt, through implementing a higher conversion price, the premium would be tax deductible. This typically would require paying a higher interest rate to induce investors to purchase the higher conversion price convertible debt, which is also unattractive to the issuer.

In view of the foregoing, it would be desirable to decrease the risk issuers assume by issuing convertible debt, while improving the accounting and tax treatment of efforts to hedge risks associated with the conversion feature, for example, of such convertible debt.

### SUMMARY

In various embodiments of the present invention, aggregate transactions and methods for structuring aspects of aggregate transactions are provided.

In certain embodiments, an aggregate transaction is provided that includes a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component; and, the convertible debt hedge includes a derivative contract having a strike price structured to be adjusted up to a maturity date of the derivative contract.

In other embodiments, an aggregate transaction is provided that includes a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component; and, at least a portion of the convertible debt hedge is structured to be exercised automatically upon conversion of at least a portion of the convertible debt component by the investor.

In other embodiments, an aggregate transaction is provided that includes a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component; and, the convertible debt hedge includes a derivative contract structured to be voidable at the option of at least one of the issuer and a counter-party to the derivative contract if the investor exercises a change of control put on the convertible debt component.

In other embodiments, an aggregate transaction is provided that includes a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component; and, the convertible debt hedge includes a derivative contract structured to be automatically terminated if the investor exercises a change of control put on the convertible debt component.

In other embodiments, an aggregate transaction is provided that includes a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component; and, the convertible debt hedge further includes a derivative contract structured to become voidable at the option of at least one of the issuer and the counter-party to the derivative contract upon an event of default of the convertible debt component by the issuer.

In other embodiments, an aggregate transaction is provided that includes a convertible debt component structured for issuance to at least one investor by an issuer; a convertible debt hedge is integrated with the convertible debt component to form an integrated aggregate transaction, wherein at least one of an anti-dilution provision, a consequence of merger provision, and a concentrative event provision of the convertible debt hedge matches at least one corresponding provision of the convertible debt component; and, the convertible debt hedge further includes a derivative contract structured to be automatically terminated upon an event of default of the convertible debt component by the issuer.

As applied to various embodiments of the present invention, aggregate transactions and/or methods for structuring aggregate transactions may include the convertible debt hedge being structured to permit the issuer to settle the convertible debt hedge with a payment selected from the group consisting of cash, an amount of an underlying security, and a combination of cash and an amount of underlying security to allow the convertible debt hedge to be accounted for as an equity instrument.

Other embodiments of the present invention will become apparent to those skilled in the art upon review of the following description and figures. It is intended that all such additional embodiments are within the scope of the present invention and are protected by the claims.

### BRIEF DESCRIPTION OF THE FIGURES

FIG. 1 includes a schematic representation illustrating various features of an aggregate transaction structured in accordance with various aspects of the present invention;

FIG. 2 includes a schematic representation illustrating various entity relationships provided in accordance with various aspects of the present invention;

FIG. 3 includes a schematic representation illustrating various features of aggregate transactions structured in accordance with various aspects of the present invention;

FIG. 4 includes one example of a process flow diagram provided in accordance with various aspects of the present invention;

FIGS. 5A through 5C include various exemplary aspects of an aggregate transaction provided in accordance with the present invention; and,

FIG. 6 includes a schematic diagram illustrating examples of system and computer-readable media embodiments provided in accordance with the present invention.

### DESCRIPTION

As employed herein, an “aggregate transaction” includes two or more investments, instruments, components, derivative contracts, and/or transactions. One example of an “aggregate transaction” structured in accordance with the present invention is a transaction that includes a convertible debt component and a convertible debt hedge.

As employed herein, an “investor” includes any financial entity, institutional entity, corporate entity, government entity, and/or individual entity capable of managing, transacting, maintaining and/or performing one or more financial or investment functions in accordance with various embodiments of the present invention. It can be appreciated that the term “investor” includes entities such as, for example and without limitation, hedge funds, mutual funds, family offices, separately managed accounts, limited partnerships, trusts, and/or other entities, institutions and/or accounts which can be structured to invest in accordance with various aspects of the present invention.

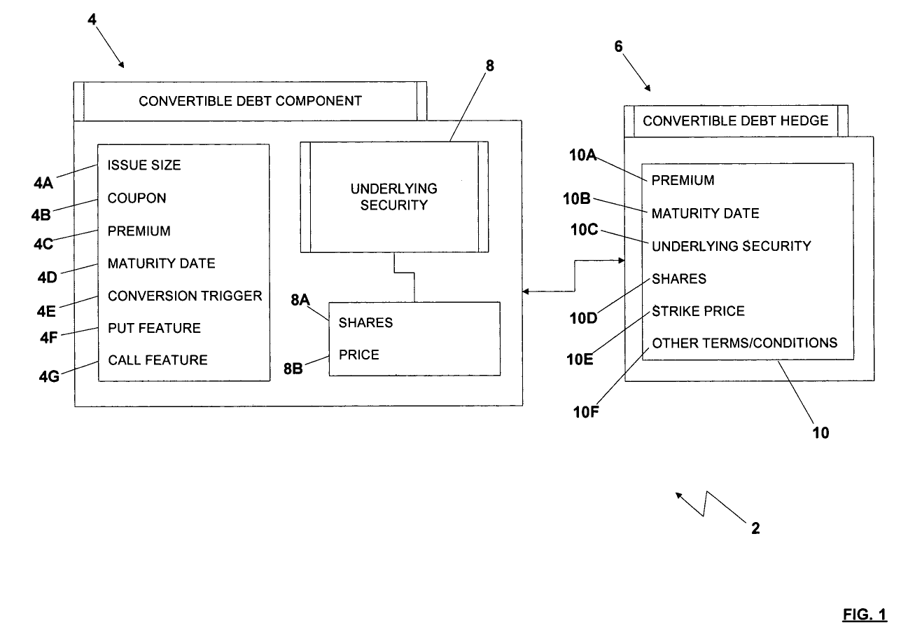

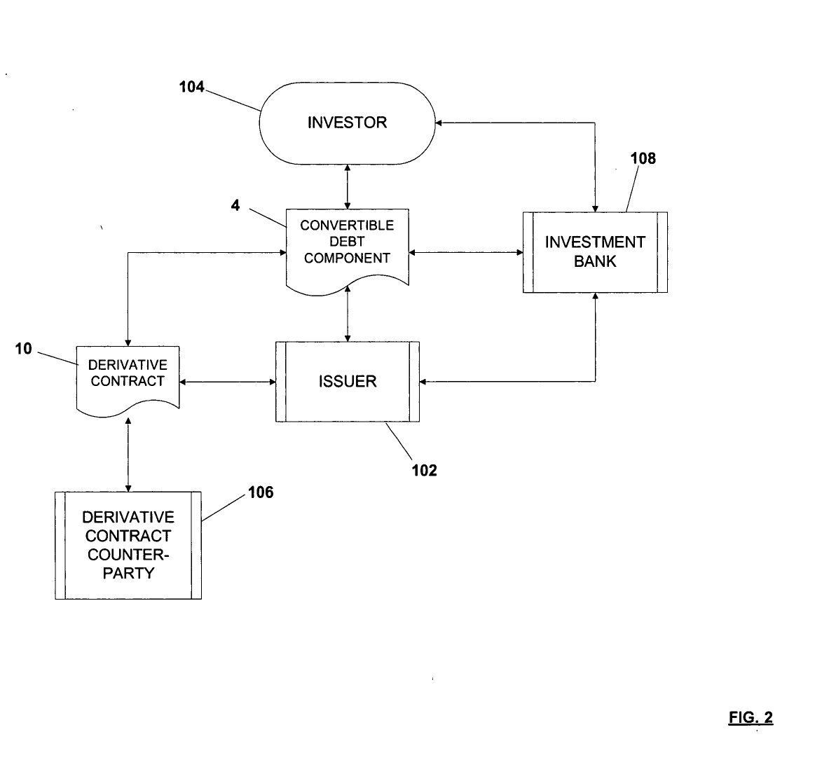

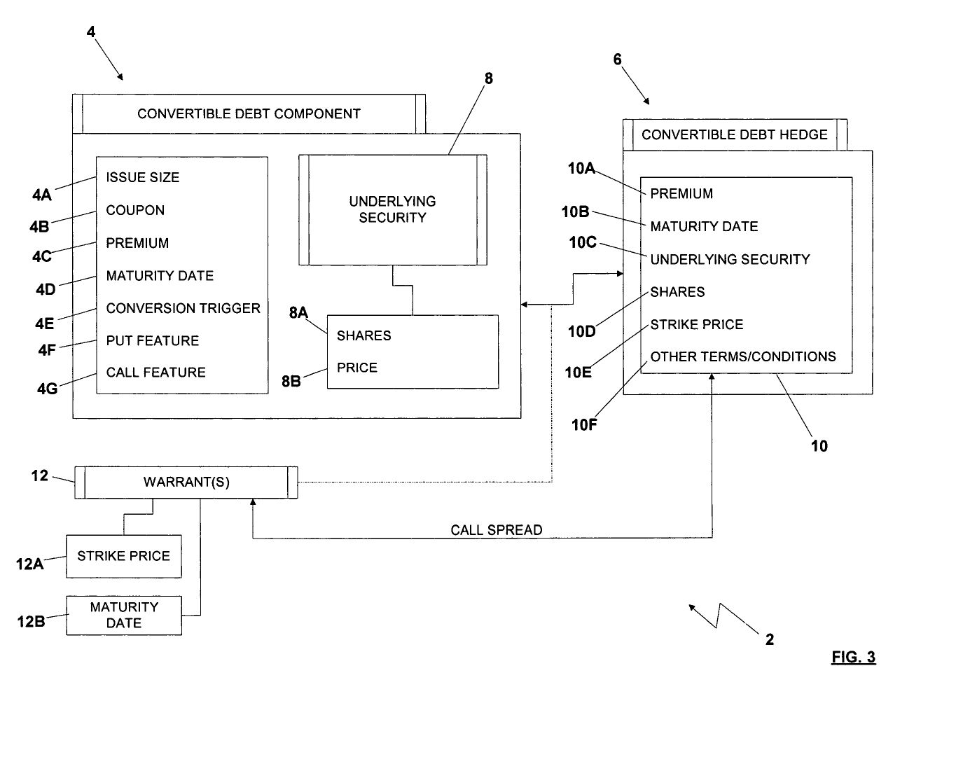

As employed herein, an “issuer” includes any financial entity, institutional entity, corporate entity, government entity, financial institution, business, company, firm, and/or other entity capable of performing one or more financial functions, investment functions, and/or other functions in association with practice of various aspects of the present invention. A suitable “issuer” may undertake an aggregate transaction, for example, including issuing a convertible debt component to an investor while entering into a convertible debt hedge. Referring now to FIGS. 1 through 3, an aggregate transaction 2 structured for use by an issuer 102 is provided in accordance with various embodiments of the present invention. The aggregate transaction 2 includes a convertible debt component 4 and a convertible debt hedge 6. In various aspects, the convertible debt hedge 6 may be “integrated” with the convertible debt component 4 in the aggregate transaction 2. The term “integrated” as applied with respect to the relationship between the convertible debt component 4 and the convertible debt hedge 6 means that matched correspondence exists between one or more features of the convertible debt component 4 and one or more features of the convertible debt hedge 6. In addition, as applied herein, an “integrated” aggregate transaction 2 is one that includes one or more of the following additional features: the convertible debt hedge 6 is structured to include a derivative contract (see below—discussion of derivative contracts) having a strike price that is adjusted up to a maturity date of the derivative contract; at least a portion of the convertible debt hedge 6 is structured to be automatically exercised upon conversion of at least a portion of the convertible debt component 4 by an investor 104; the convertible debt hedge 6 includes a derivative contract structured to be voidable at the option of at least one of the issuer 102 and a counter-party to the derivative contract, or structured to be automatically terminated in certain embodiments, if the investor 104 exercises a change of control put on the convertible debt component 4; and/or, the convertible debt hedge 6 includes a derivative contract structured to become voidable at the option of at least one of the issuer 102 and a counter-party to the derivative contract, or structured to be automatically terminated in certain embodiments, upon an event of default of the convertible debt component 4 by the issuer 102.

In various aspects, the integration of the aggregate transaction 2 exists to a degree sufficient to permit the aggregate transaction 2 to be treated as a single instrument for at least one accounting purpose and/or at least one tax purpose. It can be appreciated that single-instrument treatment of the aggregate transaction 2 may result in beneficial tax and/or accounting consequences for the issuer 102 in accordance with applicable laws, regulations, rules, standards, principles and/or policies. In various aspects, achieving sufficient integration of the convertible debt component 4 and the convertible debt hedge 6 may require meeting a number of tests that determine the degree of similarity of the aggregate transaction 2 to comparable non-convertible debt instruments. In other aspects, the integrated aggregate transaction 2 may be treated as a contingent debt instrument for tax and/or accounting purposes.

The convertible debt component 4 may possess a number of features such as, for example and without limitation, an issue size 4A, a coupon 4B, a premium 4C, a maturity date 4D, a conversion trigger 4E, a put feature 4F, and/or a call feature 4G. In various aspects, the convertible debt component 4 may include a note, a bond, or other debt instrument. In addition, the convertible debt component 4 is associated with a security into which the convertible debt component 4 is convertible, i.e., underlying security 8. The underlying security 8 may include a number of shares 8A having a price 8B that may vary according to prevailing market conditions. In certain aspects, the underlying security 8 may be common stock of the issuer 102, for example.

The conversion trigger 4E is the price paid for shares of the underlying security 8 upon conversion of the convertible debt component 4 by an investor 104, and is typically at a premium to the market value of the underlying shares 8A as determined prior to issuance of the convertible debt component 4 to the investor 104. In certain aspects, the put feature 4F of the convertible debt component 4 may include, for example, a puttable-at-par feature or a puttable-at-accreted-value feature (e.g., for zero-coupon bonds) that becomes effective at a period or periods of time after inception of the aggregate transaction 2. In other aspects, the call feature 4G of the convertible debt component 4 may include, for example, a callable-at-par feature or a callable-at-accreted-value feature (e.g., for zero-coupon bonds) that becomes effective at a period or periods of time after inception of the aggregate transaction 2. In certain aspects, the call feature 4G may be at a premium to par value or accreted value.

In various embodiments of the present invention, the convertible debt hedge 6, as integrated in the aggregate transaction 2 with the convertible debt component 4, may include one or more derivative contracts 10 established between the issuer 102 of the aggregate transaction 2 and a derivative contract counter-party 106. Establishing the derivative contract 10 may involve the issuer 102 purchasing one or more call options from the counter-party 106. In various aspects, the derivative contract 10 may include one or more features such as, for example and without limitation, a premium 10A paid to the counter-party, a maturity date 10B, a underlying security 10C, and a number of shares 10D of the underlying security 10C for which the call option(s) may be exercised. In certain aspects, the underlying security 10C may be the common stock of the issuer 102, for example. In addition, the derivative contract 10 may have a strike price 10E (i.e., the price at which the issuer 102 purchases shares of the underlying security 10C when the derivative contract 10 is exercised) that may be fixed or may be adjusted at periodic times until termination/maturity of the derivative contract 10. The strike price 10E may also be adjusted in a non-periodic fashion or even continuously. In various aspects, the derivative contract 10 may also have one or more other terms/conditions 10F that may be matched with one or more features of the convertible debt component 4 to provide the integrated aggregate transaction 2.

It can be appreciated that the convertible debt hedge 6 (including the derivative contract 10) may be documented using an agreement between the issuer 102 and the counter-party 106 that incorporates by reference one or more features of the convertible debt component 4. As discussed above, matching features between the convertible debt component 4 and the convertible debt hedge 6, and providing at least one additional feature (see above discussion), may be accomplished to a degree sufficient to permit the convertible debt hedge 6 to be considered integrated with the convertible debt component 4 for purposes of tax and/or accounting treatment. It can be seen that matching one or more features of the convertible debt component 4 to one or more features of the derivative contract 10 may also simplify the pricing of the convertible debt hedge 4. Matching features may also reduce costs to the issuer 102 normally associated with mismatches between put dates or maturity dates of the convertible debt component 4 and expiration of call protection provided by the convertible debt hedge 6. In certain embodiments, the maturity date 10B of the derivative contract 10 (e.g., an expiration date of a call option), for example, may match a period associated with the put feature 4F and/or a period associated with the call feature 4G of the convertible debt component 4. In another embodiment, the maturity date 4D of the convertible debt component 4 matches the maturity date 10B of the convertible debt hedge 6, for example. In other aspects, the derivative contract 10 may be structured to provide for the issuer 102 to purchase a type of underlying security 10C and an amount of shares 10D that matches the type of the underlying security 8 and the amount of shares 8A. Other features that may be matched as part of integrating the aggregate transaction 2 include provisions such as, for example and without limitation, anti-dilution provisions, consequence of merger provisions, concentrative event provisions, events of default, and/or various other provisions, terms and conditions.

In various embodiments described herein, the issuer 102 may elect to settle the convertible debt hedge 6 with payment in cash, an amount of the underlying security 10C, or a combination of cash and an amount of the underlying security 10C. As a result, the convertible debt hedge 6 may be accounted for as an equity instrument rather than a derivative instrument.

In one example, the strike price 10E at which the issuer 102 purchases the underlying security 10C pursuant to the derivative contract 10 may be set so that the aggregate transaction 2 replicates the cash flows of a similar but non-convertible bond sold at a discount that accretes to full value by the earlier of (1) the first date that the put feature 4F becomes effective (e.g., put date), or (2) the maturity date 10B. It can be seen that the initial strike price 10E may be made equal to the issue size 4A of the convertible debt component 4, less the premium 10A paid to the counter-party 106 by the issuer 102 to enter into the derivative contract 10. The strike price 10E may be structured to increase, for example, until the maturity date 10B of the derivative contract 10, such that the strike price 10E at the maturity date 10B is equal to the issue size 4A of the convertible debt component 4. In various aspects of the present invention, the aggregate transaction 2 may be structured to behave like a discount bond. In certain aspects, the strike price 10E of the convertible debt hedge 6 is equivalent to the accreted value of a hypothetical discount bond.

In various aspects of the present invention, the call option(s) of the derivative contract 10 are exercisable only if a portion of the convertible debt component 4 is converted by the investor 104. Upon conversion of any portion of the convertible debt component 4 up to the maturity date 10B of the derivative contract 10, an applicable amount of the underlying security 10C may be automatically purchased by the issuer 102 in accordance with the terms of the derivative contract 10. If the automatic purchase is triggered at a time when the value of the underlying security 10C is less than the applicable strike price 10E, then the derivative contract 10 can be structured to terminate or be voidable (or an applicable portion of the derivative contract 10E may terminate or be voidable if less than all of the convertible debt component 4 has been converted). In certain aspects, termination ensures that the integrated aggregate transaction 2 behaves like a discount bond if the investor 104 converts at a time when the value of the underlying security 10C is less than the applicable strike price 10E. In other aspects, an applicable amount of the underlying security 10C may be purchasable (i.e., not automatically purchased) by the issuer 102 pursuant to conversion of the convertible debt component 4 by the investor 104.

In various embodiments of the present invention, the derivative contract 10 can be structured to terminate automatically, if the investor 104 exercises a change of control put, for example, or if an event of default on the convertible debt component 4 occurs (e.g., the issuer 102 fails to make payments when due), or if another reason for termination arises. Unlike conventional derivative contracts employed for options trading, the derivative contract 10 of the convertible debt hedge 6 can be structured to become void upon termination, rather than providing for payment equal to the fair value of the derivative contract 10 by either the issuer 102 or the counter-party 106. In alternative embodiments, if a change of control put is exercised, or the issuer 102 defaults or fails to meet a covenant of the convertible debt component 4, the convertible debt hedge 6 may be structured so that it does not terminate automatically. For example, depending on the circumstances, the convertible debt hedge 6 may become voidable at the option of the issuer 102 or the counter-party 106. In certain aspects, a default condition or a failed covenant (as defined through the terms and conditions of the convertible debt component 4) may give the investor 104 the right to accelerate maturity of the convertible debt component 4. In other aspects, if the investor 104 chooses to put the convertible debt component 4 to the issuer 102 upon a change of control, for example, then the convertible debt hedge 6 becomes void or voidable.

In other embodiments of the present invention, the aggregate transaction 2 may also be associated with the sale of one or more warrants 12 by the issuer 102 to a third party. In various aspects, the warrants 12 may include standard, over-the-counter call options sold by the issuer 102 to another party, which may be an investment bank 108, for example, underwriting issuance of the convertible debt component 4. The amount and strike price 12A of the call options comprising the warrants 12 may be set to reduce the cost to the issuer 102 of the convertible debt hedge 6 to a desired level. In various aspects, a maturity date 12B for the warrants 12 is structured to extend beyond the maturity date 10B of the derivative contract 10 of the convertible debt hedge 6. The effect of associating the convertible debt hedge 6 with the warrant 12 in a transaction is that the issuer 102 may issue the convertible debt component 6 with a relatively more defined and predictable level of risk with respect to costs incurred through conversion of the convertible debt component 4. In various aspects, a more defined and predictable level of risk may be obtained by the issuer 102 through creation of a call spread between the terms of the derivative contract 10 and the terms of the warrant 12. To create the call spread, for example, the warrant 12 may have a comparatively higher strike price 12A than the strike price of the derivative contract 10.

In other aspects of the present invention, a financial institution such as an investment bank 108, for example, may be associated with the issuer 102 and/or the investor 104. In various aspects, the investment bank 108 may structure one or more transactions including one or more of the components 4, 6 of the integrated aggregate transaction 2 as previously discussed. The investment bank 108 may price the convertible debt component 4 of the aggregate transaction 2, for example, for an offering using pricing models, data regarding similarly structured transactions, feedback from various investors, and/or other factors. In addition, the investment bank 108 may market the convertible debt component 4 to potential investors 104, underwrite the issuance of the convertible debt component 4, contract with the issuer 102 to establish the derivative contract 10, and/or arrange/monitor/process various aspects of a transaction such as, for example, activities involved with structuring the aggregate transaction 2.

From a tax perspective for various aspects of the present invention, sufficient integration of the convertible debt component 4 with the convertible debt hedge 6 in the aggregate transaction 2 provides tax deductions to the issuer 102 for interest paid on the convertible debt component 4 and the premium 10A paid on the derivative contract 10. The integrated aggregate transaction 2 may be treated for tax purposes as a non-convertible discount bond because the terms, cash flows and effective lack of a conversion feature for the integrated aggregate transaction 2 may be deemed to substantially replicate non-convertible debt issued at a discount. This is a desirable situation, because premiums paid by the issuer 102 on options written on the common stock of the issuer 102 are typically not deductible. In various aspects, the integrated aggregate transaction 2 is structured to behave like straight debt and, therefore, the issuer 102 may take tax deductions based on a straight debt cost. In addition, issuance of the integrated aggregate transaction 2, unlike a contingent payment debt instrument, for example, involves no recapture of deductions previously taken by the issuer 102. The warrant 12, if associated in a transaction with the integrated aggregate transaction 2, may be treated from a tax perspective in the usual manner for such instruments.

From an accounting perspective, with regard to practice of the present invention, the issuer 102 may treat the convertible debt component 4 and the warrant 12, if included, in the ordinary manner that such instruments are treated. The convertible debt hedge 6 may be treated as an option rather than a forward contract, because the issuer 102 only purchases the underlying security 10C pursuant to the derivative contract 10 if the value of the underlying security 10C exceeds the strike price 10E. Because the convertible debt hedge 6 may comply with accounting rules governing classification of instruments as equity rather than derivatives, the issuer 102 should not be required to account for changes in value during the life of the convertible debt hedge 6. The foregoing may reduce the reported income unpredictability typically associated with the issuer 102 purchasing call options on its own common stock.

With regard to position limits in view of practice of the present invention, the convertible debt hedge 6 is substantively different in comparison to a call option on common stock, for example. In various aspects, the issuer 102 does not retain control of the decision to purchase the underlying security 10C through the derivative contract 10 of the convertible debt hedge 6. Rather, the exercise of the call option through the convertible debt hedge 6 is dependent on conversion of the convertible debt component 4 by the investor 104. Therefore, because the exercise decision is at least indirectly controlled by the investor 104, the convertible debt hedge 6 can be characterized as a forward hedge of the convertible debt component 4 for purposes of position limits.

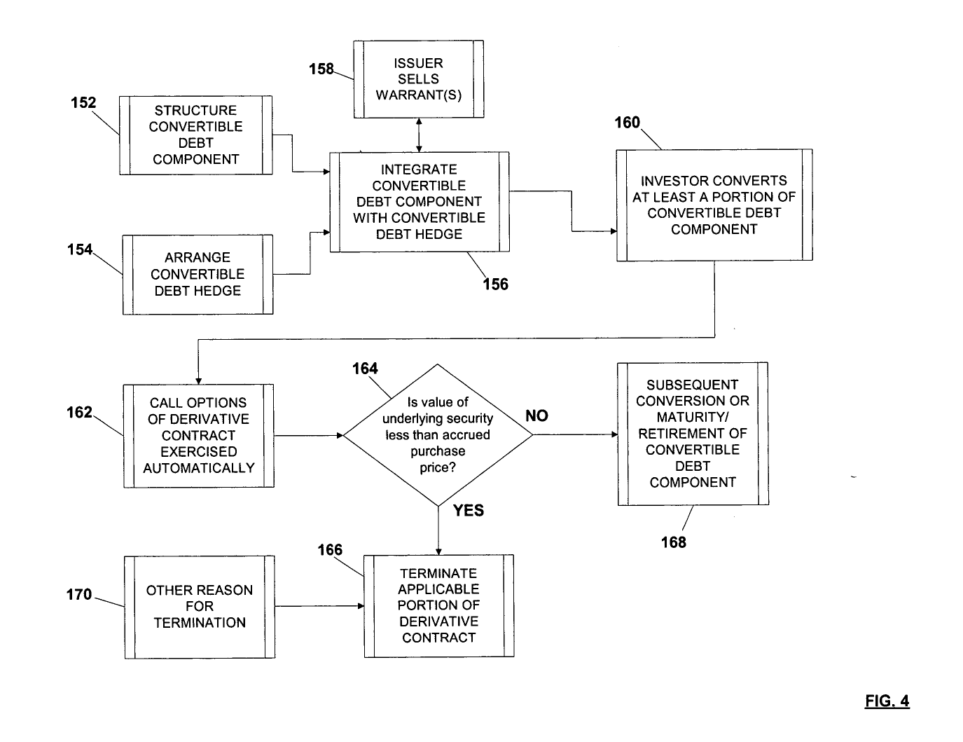

Referring now to FIG. 4, and in view of the foregoing discussion, various exemplary aspects are illustrated for a process flow embodiment of the present invention. In step 152, the convertible debt component 4 is structured for a transaction between the issuer 102 and the investor 104. In step 154, the convertible debt hedge 6, including the derivative contract 10, is arranged between the issuer 102 and the derivative contract counter-party 106. The convertible debt component 4 and the convertible debt hedge 6 may then be integrated in step 156 to provide the integrated aggregate transaction 2. In step 158, the integrated aggregate transaction 2 may also be associated with the sale of one or more warrants 12 by the issuer 102 to a third party to attempt to reduce costs associated with the convertible debt hedge 6.

In step 160, at least a portion of the convertible debt component 4 is converted into the underlying security 8 by the investor 104. The call options of the derivative contract 10 may be exercised automatically in step 162 in connection with conversion of the convertible debt component 4 in step 160. In addition, an applicable amount of the underlying security 10C may be automatically purchased in step 162 in accordance with the terms of the derivative contract 10 to meet the conversion by the investor 104 in step 160. As determined in step 164, if the automatic purchase of step 162 is triggered at a time when the value of the purchased underlying security 10C is less than the applicable strike price 10E, then an applicable portion of the derivative contract 10 can be structured to terminate in step 166. Otherwise, the remaining portion, if any, of the convertible debt component 4 may be subsequently converted or proceed to maturity/retirement in step 168. In certain embodiments, the call options of the derivative contract 10 may be exercisable (i.e., not exercised automatically) in step 162 in connection with conversion of the convertible debt component 4 in step 160. In addition, an applicable amount of the underlying security 10C may be purchasable (i.e., not automatically purchased) in step 162. In various aspects, at least a portion of the derivative contract 10 can be structured to terminate automatically in step 166 if the investor 104 exercises a change of control put, for example, or if an event of default associated with the convertible debt component 4 occurs, or if another reason for termination arises in step 170. In other aspects, the derivative contract 10 may be structured to be voidable, rather than terminate automatically in step 166, at the option of the issuer 102 or the counter-party 106, for example, depending on the reason for termination.

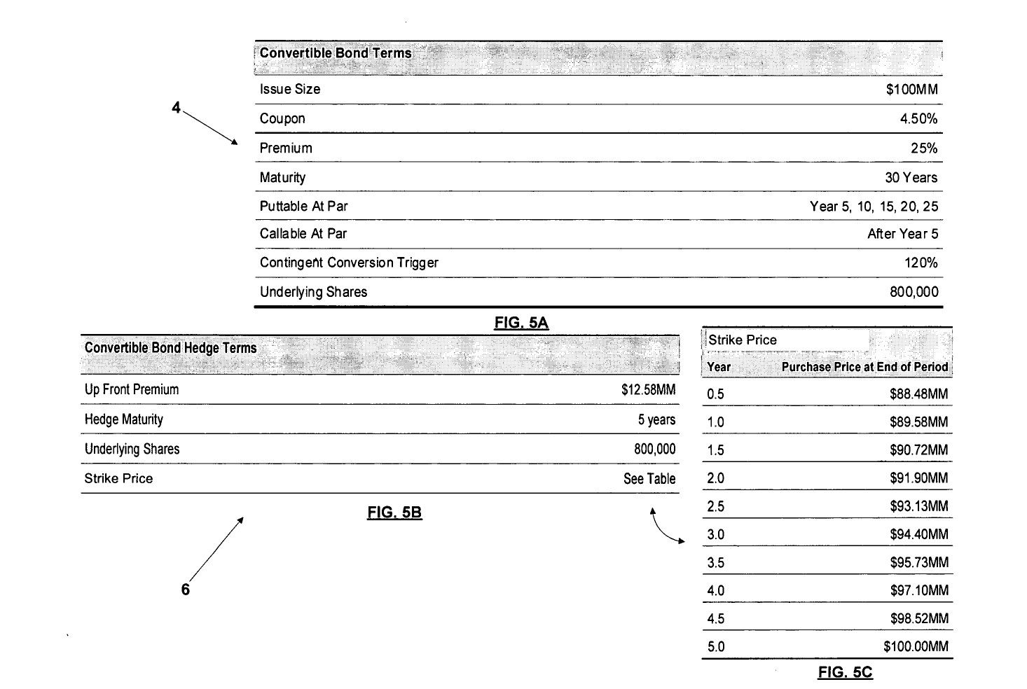

Referring now to FIGS. 5A through 5C, various examples are provided for various aspects of the integrated aggregate transaction 2 in accordance with the present invention. The aggregate transaction 2 includes the convertible debt component 4, which is a convertible bond issued by the issuer 102 to the investor 104, and the convertible debt hedge 6 is a convertible bond hedge. For illustration purposes, the following assumptions are made: the underlying security 8 is common stock of the issuer 102, the current stock price of the underlying security 8 is $100 per share; the dividend yield is 2%; five-year cost of debt for the issuer 102 is 9%; volatility of the common stock is 30%; pricing for the convertible bond is 5% cheap; and, pricing for the convertible bond hedge 6 is fair value.

Referring to FIG. 5A, the terms of the convertible bond 4 include an issue size 4A of $100 MM based on a premium 4C of 25% for 800,000 shares 8A of the underlying security 8 at a price 8B of $100 per share. The convertible bond 4 is issued with a coupon 4B of 4.5% with a fixed maturity date 4D of 30 years from issuance of the convertible bond 4. After issuance and up to the 30-year maturity date 4D, the convertible bond 4 is puttable-at-par 4F after years 5, 10, 15, 20, and 25, and is callable-at-par 4G after year 5. The conversion price in the event of conversion is based on the premium 4C (i.e., 25% over the price 8B of the underlying security 8, or $125 per share). The convertible bond 4 has a contingent conversion trigger 4E of 120%, which is the price above the conversion price at which the conversion right becomes exercisable, allowing the convertible debt 4 to be converted into the underlying security 8 by the investor 104 (i.e., 120% of a conversion price of $125 per share is $150 per share).

As shown in FIG. 5B, the terms of the convertible bond hedge 6 arranged between the issuer 102 and the derivative contract counter-party 106 include an up front premium 10A of $12.58 MM paid by the issuer 102 to the counter-party 106. The convertible bond hedge 6 includes a fixed maturity date 10B of five years from creation of the convertible bond hedge 6 and is based on 800,000 shares 10D of a underlying security 10C that matches the underlying security 8. The strike price 10E at which the issuer 102 purchases shares of the underlying security 10C from the counter-party 106 is provided as shown in the tabulation of FIG. 5C. It can be seen that the strike price 10E increases at periodic times (i.e., every six months) until the maturity date 10B of the convertible bond hedge 6.

Through the examples shown in FIGS. 5A through 5C, it can be seen that the issuer 102 may be able to treat the integrated aggregate transaction 2 for tax and accounting purposes as a discount bond, for example, issued for $87.42 MM (i.e., the issue size 4A of $100 MM less the premium 10A of $12.58 MM equals $87.42 MM). It can be seen that integration of the aggregate transaction 2 is achieved through matching terms of the convertible bond 4 to terms of the convertible bond hedge 6 (e.g., matching the type and amount of the underlying security 8 to the type and amount of the underlying security 10C; matching the issue size 4A to the final strike price 4E; matching the put feature 4F with the maturity date 10B; and, matching the call feature 4G with the maturity date 10B). Sufficient integration provides the issuer 102 with deductions on both the coupons 4B paid on the convertible bond 4 and the premium 10A paid for the convertible bond hedge 6, which premium 10A can be considered an original issue discount for the integrated aggregate transaction 2. It can be appreciated that deduction of the premium 10A is a significant benefit of the present invention, because the issuer 102 normally cannot deduct premiums paid for options on its own common stock.

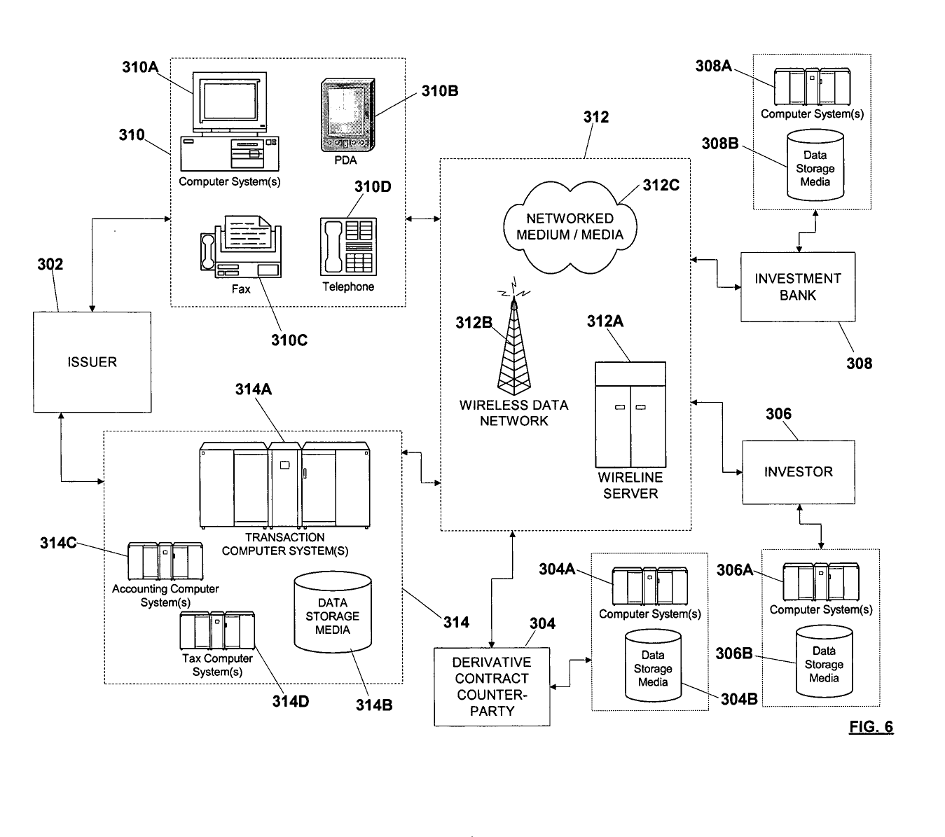

Referring now to FIG. 6, various system and computer-readable media embodiments provided in accordance with the present invention are illustrated. As shown, an issuer 302 may communicate and/or exchange data with a derivative contract counter-party 304, an investor 306, and/or an investment bank 308. In various aspects, the issuer 302 may be operatively associated with one or more communications devices 310 such as, for example and without limitation, a computer system 310A, a personal digital assistant 310B, a fax machine 310C, and/or a telephone 310D (e.g., a wireline telephone, a wireless telephone, a pager, and the like), and/or other like communication devices. The communication devices 310 permit the issuer 302, the derivative contract counter-party 304, the investor 306, and/or the investment bank 308 to communicate between/among each other through one or more communication media 312, such as by employing electronic mail communicated through one or more computer systems, for example. The communication media 312 may include, for example and without limitation, wireline communication means such as a wireline server 312A, a wireless data network 312B, and/or a connection through a networked medium or media 312C (e.g., the Internet, an extranet, an intranet, a wide area network (WAN), and/or a local area network (LAN)).

In addition, the issuer 302 (as well as any one or more of the derivative contract counter-party 304, the investor 306, and/or the investment bank 308) may be operatively associated with one or more data processing/storage devices such as data processing/storage devices 314, for example. The issuer 302 may be operatively associated with one or more transaction computer systems 314A, for example, and/or one or more data storage media 314B configured to receive, store, analyze and/or otherwise process data and other information in association with communications that occur between/among the issuer 302, the derivative contract counter-party 304, the investor 306, and/or the investment bank 308. In various aspects, the issuer 302 may be operatively associated, for example, with one or more accounting computer systems 314C and/or one or more tax computer systems 314D. The accounting/tax computer systems 314C, 314D may be configured for receiving, storing, and/or processing accounting/tax data, among other types of data, associated with one or more aspects of the aggregate transaction 2, for example, of the present invention.

In various aspects, the derivative contract counter-party 304 may be operatively associated with one or more computer systems 304A and/or one or more data storage media 304B. In other aspects, the investor 306 may be operatively associated with one or more computer systems 306A and/or one or more data storage media 306B. In still other aspects, the investment bank 308 may be operatively associated with one or more computer systems 308A and/or one or more data storage media 308B. It can be appreciated that one or more of the computer systems 304A, 306A, 308A, 314A, 314C, 314D and/or one or more of the data storage media 304B, 306B, 308B, 314B may be employed to communicate, store, analyze, and/or otherwise process data related to financial transactions occurring between/among the issuer 302, the derivative contract counter-party 304, the investor 306, and/or the investment bank 308.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, digital versatile discs (DVD), optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

As used herein, a “computer” or “computer system” may be, for example and without limitation, either alone or in combination, a personal computer (PC), server-based computer, server, main frame, microcomputer, minicomputer, laptop, personal data assistant (PDA), cellular phone, pager, processor, including wireless and/or wireline varieties thereof, and/or any other computerized device capable of configuration for processing data for either standalone application or over a networked medium or media. Computers and computer systems disclosed herein can include memory for storing certain software applications used in obtaining, processing, storing and/or communicating data. It can be appreciated that such memory can be internal or external, remote or local, with respect to its operatively associated computer or computer system. The memory can also include any means for storing software, including a hard disk, an optical disk, floppy disk, ROM (read only memory), RAM (random access memory), PROM (programmable ROM), EEPROM (extended erasable PROM), and other suitable computer-readable media.

It is to be understood that the figures and descriptions of embodiments of the present invention have been simplified to illustrate elements that are relevant for a clear understanding of the present invention, while eliminating, for purposes of clarity, other elements. Those of ordinary skill in the art will recognize, however, that these and other elements may be desirable for practice of various aspects of the present embodiments. However, because such elements are well known in the art, and because they do not facilitate a better understanding of the present invention, a discussion of such elements is not provided herein.

It can be appreciated that, in various embodiments disclosed herein, a single component/element/entity can be replaced by multiple components/elements/entities and multiple components/elements/entities can be replaced by a single component/element/entity, to perform a given function or functions. Except where such substitution would not be operative to practice aspects of the present embodiments, such substitution is considered to be within the scope of the present invention.

Examples presented herein, including operational examples, are intended to illustrate potential implementations of the present invention. It can be appreciated that such examples are intended primarily for purposes of illustration. No particular aspect or aspects of the example embodiments described herein are intended to limit the scope of the present invention.

It should be appreciated that figures presented herein are intended for illustrative purposes and are not intended as construction drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the claims.

1. An aggregate transaction comprising:
a convertible debt component structured for issuance to at least one investor by an issuer;
a convertible debt hedge integrated with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
said convertible debt hedge including a derivative contract having a strike price structured to be adjusted up to a maturity date of said derivative contract.

2. The aggregate transaction of claim 1, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

3. The aggregate transaction of claim 1, further comprising said derivative contract having at least one call option structured to be exercisable upon conversion of at least a portion of said convertible debt component by said investor.

4. The aggregate transaction of claim 3, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

5. The aggregate transaction of claim 1, further comprising said derivative contract having at least one call option structured to be exercised automatically upon conversion of at least a portion of said convertible debt component by said investor.

6. The aggregate transaction of claim 5, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

7. The aggregate transaction of claim 1, further comprising said derivative contract being structured to be voidable at the option of at least one of said issuer and a counter-party to said derivative contract if said investor exercises a change of control put on said convertible debt component.

8. The aggregate transaction of claim 7, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

9. The aggregate transaction of claim 1, further comprising said derivative contract being structured to be terminated automatically if said investor exercises a change of control put on said convertible debt component.

10. The aggregate transaction of claim 9, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

11. The aggregate transaction of claim 1, wherein said convertible debt hedge is structured to become voidable at the option of at least one of said issuer and a counter-party to said derivative contract upon an event of default on said convertible debt component by said issuer.

12. The aggregate transaction of claim 11, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

13. The aggregate transaction of claim 1, wherein said convertible debt hedge is structured to terminate automatically upon an event of default on said convertible debt component by said issuer.

14. The aggregate transaction of claim 13, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

15. The aggregate transaction of claim 1, wherein said strike price is structured to increase at periodic times until maturity of said derivative contract.

16. The aggregate transaction of claim 15, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

17. The aggregate transaction of claim 1, wherein at least a maturity date of said derivative contract matches at least a put date of said convertible debt component.

18. The aggregate transaction of claim 17, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

19. The aggregate transaction of claim 1, wherein at least a maturity date of said derivative contract matches at least a maturity date of said convertible debt component.

20. The aggregate transaction of claim 19, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

21. The aggregate transaction of claim 1, wherein at least one underlying security feature of said derivative contract matches at least one underlying security feature of said convertible debt component.

22. The aggregate transaction of claim 21, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

23. The aggregate transaction of claim 1, wherein said derivative contract includes at least one call option.

24. The aggregate transaction of claim 23, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

25. The aggregate transaction of claim 1, further comprising at least one warrant associated with said integrated aggregate transaction.

26. The aggregate transaction of claim 25, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

27. The aggregate transaction of claim 25, further comprising said warrant being structured to create a call spread between said derivative contract and said warrant.

28. The aggregate transaction of claim 27, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

29. An aggregate transaction comprising:
a convertible debt component structured for issuance to at least one investor by an issuer;
a convertible debt hedge integrated with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
at least a portion of said convertible debt hedge being structured to be exercised automatically upon conversion of at least a portion of said convertible debt component by said investor.

30. The aggregate transaction of claim 29, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

31. The aggregate transaction of claim 29, wherein said convertible debt hedge includes a derivative contact having at least one call option, at least a portion of said derivative contract being structured to terminate if exercise of said call option occurs at a time when the value of a security purchased pursuant to said call option is less than a current strike price of said derivative contract.

32. The aggregate transaction of claim 31, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

33. The aggregate transaction of claim 29, wherein said convertible debt hedge includes a derivative contract structured for said issuer, upon conversion of said convertible debt component, to purchase a type and amount of an underlying security of said derivative contract matching a type and amount of an underlying security of said convertible debt component.

34. The aggregate transaction of claim 33, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

35. The aggregate transaction of claim 29, further comprising said convertible debt hedge including a derivative contract structured to be voidable at the option of at least one of said issuer and a counter-party to said derivative contract if said investor exercises a change of control put on said convertible debt component.

36. The aggregate transaction of claim 35, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

37. The aggregate transaction of claim 29, further comprising said convertible debt hedge including a derivative contract structured to terminate automatically if said investor exercises a change of control put on said convertible debt component.

38. The aggregate transaction of claim 37, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

39. The aggregate transaction of claim 29, further comprising said convertible debt hedge including a derivative contract, wherein said convertible debt hedge is structured to become voidable at the option of at least one of said issuer and a counter-party to said derivative contract upon an event of default on said convertible debt component by said issuer.

40. The aggregate transaction of claim 39, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

41. The aggregate transaction of claim 29, further comprising said convertible debt hedge including a derivative contract, wherein said convertible debt hedge is structured to terminate automatically upon an event of default on said convertible debt component by said issuer.

42. The aggregate transaction of claim 41, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

43. The aggregate transaction of claim 29, wherein at least a maturity date of a derivative contract of said convertible debt hedge matches at least a put date of said convertible debt component.

44. The aggregate transaction of claim 43, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

45. The aggregate transaction of claim 29, wherein at least a maturity date of a derivative contract of said convertible debt hedge matches at least a maturity date of said convertible debt component.

46. The aggregate transaction of claim 45, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

47. The aggregate transaction of claim 29, wherein at least one underlying security feature of a derivative contract of said convertible debt hedge matches at least one underlying security feature of said convertible debt component.

48. The aggregate transaction of claim 47, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

49. The aggregate transaction of claim 29, further comprising at least one warrant associated with said integrated aggregate transaction.

50. The aggregate transaction of claim 49, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

51. The aggregate transaction of claim 49, further comprising said warrant being structured to create a call spread between a derivative contract of said convertible debt hedge and said warrant.

52. The aggregate transaction of claim 51, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

53. An aggregate transaction comprising:
a convertible debt component structured for issuance to at least one investor by an issuer;
a convertible debt hedge integrated with said convertible debt component to form an integrated aggregate transaction, wherein at least one of an anti-dilution provision, a consequence of merger provision, and a concentrative event provision of said convertible debt hedge matches at least one corresponding provision of said convertible debt component; and, said convertible debt hedge including a derivative contract structured to be voidable at the option of at least one of said issuer and a counter-party to said derivative contract if said investor exercises a change of control put on said convertible debt component.

54. The aggregate transaction of claim 53, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

55. The aggregate transaction of claim 53, wherein said convertible debt hedge is structured to become voidable upon an event of default of said convertible debt component by said issuer.

56. The aggregate transaction of claim 55, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

57. The aggregate transaction of claim 53, wherein said convertible debt hedge is structured to terminate automatically upon an event of default of said convertible debt component by said issuer.

58. The aggregate transaction of claim 57, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

59. The aggregate transaction of claim 53, wherein at least a maturity date of said derivative contract matches at least a put date of said convertible debt component.

60. The aggregate transaction of claim 59, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

61. The aggregate transaction of claim 53, wherein at least a maturity date of said derivative contract matches at least a maturity date of said convertible debt component.

62. The aggregate transaction of claim 61, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

63. The aggregate transaction of claim 53, wherein at least one underlying security feature of said derivative contract matches at least one underlying security feature of said convertible debt component.

64. The aggregate transaction of claim 63, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

65. The aggregate transaction of claim 53, further comprising at least one warrant associated with said integrated aggregate transaction.

66. The aggregate transaction of claim 65, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

67. The aggregate transaction of claim 65, further comprising said warrant being structured to create a call spread between said derivative contract and said warrant.

68. The aggregate transaction of claim 67, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

69. An aggregate transaction comprising:
a convertible debt component structured for issuance to at least one investor by an issuer;
a convertible debt hedge integrated with said convertible debt component to form an integrated aggregate transaction, wherein at least one of an anti-dilution provision, a consequence of merger provision, and a concentrative event provision of said convertible debt hedge matches at least one corresponding provision of said convertible debt component; and, said convertible debt hedge including a derivative contract structured to be automatically terminated if said investor exercises a change of control put on said convertible debt component.

70. The aggregate transaction of claim 69, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

71. The aggregate transaction of claim 69, wherein said convertible debt hedge is structured to become voidable upon an event of default of said convertible debt component by said issuer.

72. The aggregate transaction of claim 71, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

73. The aggregate transaction of claim 69, wherein said convertible debt hedge is structured to terminate automatically upon an event of default of said convertible debt component by said issuer.

74. The aggregate transaction of claim 73, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

75. An aggregate transaction comprising:
a convertible debt component structured for issuance to at least one investor by an issuer;
a convertible debt hedge integrated with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
said convertible debt hedge further including a derivative contract structured to become voidable at the option of at least one of said issuer and said counter-party to said derivative contract upon an event of default of said convertible debt component by said issuer.

76. The aggregate transaction of claim 75, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

77. The aggregate transaction of claim 75, wherein at least a maturity date of said derivative contract matches at least a put date of said convertible debt component.

78. The aggregate transaction of claim 77, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

79. The aggregate transaction of claim 75, wherein at least a maturity date of said derivative contract matches at least a maturity date of said convertible debt component.

80. The aggregate transaction of claim 79, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

81. The aggregate transaction of claim 75, wherein at least one underlying security feature of said derivative contract matches at least one underlying security feature of said convertible debt component.

82. The aggregate transaction of claim 81, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

83. The aggregate transaction of claim 75, wherein said derivative contract includes at least one call option.

84. The aggregate transaction of claim 83, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

85. The aggregate transaction of claim 75, further comprising at least one warrant associated with said integrated aggregate transaction.

86. The aggregate transaction of claim 85, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

87. The aggregate transaction of claim 85, further comprising said warrant being structured to create a call spread between said derivative contract and said warrant.

88. The aggregate transaction of claim 87, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

89. An aggregate transaction comprising:
a convertible debt component structured for issuance to at least one investor by an issuer;
a convertible debt hedge integrated with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
said convertible debt hedge further including a derivative contract structured to be automatically terminated upon an event of default of said convertible debt component by said issuer.

90. The aggregate transaction of claim 89, further comprising said convertible debt hedge being structured to permit said issuer to settle said convertible debt hedge with a payment selected from the group consisting of cash, an amount of an underlying security, and a combination of cash and an amount of underlying security to allow said convertible debt hedge to be accounted for as an equity instrument.

91. A method for structuring an aggregate transaction, said method comprising the steps of:
structuring a convertible debt component for issuance to at least one investor by an issuer;
arranging for integration of a convertible debt hedge with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
structuring said convertible debt hedge to include a derivative contract having a strike price structured to be adjusted up to a maturity date of said derivative contract.

92. The method of claim 91, further comprising structuring said convertible debt hedge to permit said issuer to settle said convertible debt hedge with a payment selected from the group consisting of cash, an amount of an underlying security, and a combination of cash and an amount of underlying security to allow said convertible debt hedge to be accounted for as an equity instrument.

93. A method for structuring an aggregate transaction, said method comprising the steps of:
structuring a convertible debt component for issuance to at least one investor by an issuer;
arranging for integration of a convertible debt hedge with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
structuring at least a portion of said convertible debt hedge to be automatically exercised upon conversion of at least a portion of said convertible debt component by said investor.

94. The method of claim 93, further comprising structuring said convertible debt hedge to permit said issuer to settle said convertible debt hedge with a payment selected from the group consisting of cash, an amount of an underlying security, and a combination of cash and an amount of underlying security to allow said convertible debt hedge to be accounted for as an equity instrument.

95. A method for structuring an aggregate transaction, said method comprising the steps of:
structuring a convertible debt component for issuance to at least one investor by an issuer;
arranging for integration of a convertible debt hedge with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
structuring said convertible debt hedge to include a derivative contract structured to be voidable at the option of at least one of said issuer and a counter-party to said derivative contract if said investor exercises a change of control put on said convertible debt component.

96. The method of claim 95, further comprising structuring said convertible debt hedge to permit said issuer to settle said convertible debt hedge with a payment selected from the group consisting of cash, an amount of an underlying security, and a combination of cash and an amount of underlying security to allow said convertible debt hedge to be accounted for as an equity instrument.

97. A method for structuring an aggregate transaction, said method comprising the steps of:
structuring a convertible debt component for issuance to at least one investor by an issuer;
arranging for integration of a convertible debt hedge with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
structuring said convertible debt hedge to include a derivative contract structured to be automatically terminated if said investor exercises a change of control put on said convertible debt component.

98. The method of claim 97, further comprising structuring said convertible debt hedge to permit said issuer to settle said convertible debt hedge with a payment selected from the group consisting of cash, an amount of an underlying security, and a combination of cash and an amount of underlying security to allow said convertible debt hedge to be accounted for as an equity instrument.

99. A method for structuring an aggregate transaction, said method comprising the steps of:
structuring a convertible debt component for issuance to at least one investor by an issuer;
arranging for integration of a convertible debt hedge with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
structuring said convertible debt hedge to include a derivative contract structured to become voidable at the option of at least one of said issuer and a counter-party to said derivative contract upon an event of default of said convertible debt component by said issuer.

100. The method of claim 99, further comprising structuring said convertible debt hedge to permit said issuer to settle said convertible debt hedge with a payment selected from the group consisting of cash, an amount of an underlying security, and a combination of cash and an amount of underlying security to allow said convertible debt hedge to be accounted for as an equity instrument.

101. A method for structuring an aggregate transaction, said method comprising the steps of:
structuring a convertible debt component for issuance to at least one investor by an issuer;
arranging for integration of a convertible debt hedge with said convertible debt component to form an integrated aggregate transaction, wherein at least one of an anti-dilution provision, a consequence of merger provision, and a concentrative event provision of said convertible debt hedge matches at least one corresponding provision of said convertible debt component; and,
structuring said convertible debt hedge to include a derivative contract structured to be automatically terminated upon an event of default of said convertible debt component by said issuer.

102. The method of claim 101, further comprising structuring said convertible debt hedge to permit said issuer to settle said convertible debt hedge with a payment selected from the group consisting of cash, an amount of an underlying security, and a combination of cash and an amount of underlying security to allow said convertible debt hedge to be accounted for as an equity instrument.
